(19) United States
(12) Patent Application Publication
(10) Pub. No.: US 2010/0031303 A1
(43) Pub. Date: Feb. 4, 2010

(54) Headend apparatus for data transmission over cable access network

(76) Inventors: Jin Fei Yu, Beijing (CN); Junbiao Zhang, Beijing (CN); Zhi Gang Zhang, Beijing (CN)

Correspondence Address: Robert D. Shedd, Patent Operations;THOMSON Licensing LLC, P.O. Box 5312, Princeton, NJ, 08543-5312, US

(21) Appl. No.: 12/311,373

(22) PCT Filed: Sep. 29, 2007
(86) PCT No.: PCT/CN2007/002855

§ 371 Date: Mar. 26, 2009

(30) Foreign Application Priority Data
Sep. 30, 2006 (CN) 200610140627.2

(51) Int. Cl. H04N 7/173

(52) U.S. Cl. 725/116

(57) ABSTRACT

The present invention relates to a server used to transmit Ethernet data signals from an Ethernet network to multiple cable TV network clients or receive Ethernet data signals from the multiple cable TV network clients, the server comprising multiple APs (access points), wherein the APs synchronously start a downlink transmission or an uplink transmission, and wherein during the downlink transmission the APs convert the Ethernet data signals into encoded and modulated RF signals and transmit the encoded and modulated RF signals to the multiple cable TV network clients, and during the uplink transmission the encoded and modulated RF signals from the cable TV network clients and convert the encoded and modulated RF signals into the Ethernet data signals.

### FIELD OF THE INVENTION

The present invention relates to the technology of data communication through cable access network, and more particularly to a Headend apparatus for data transmission over cable access network.

### BACKGROUND OF THE INVENTION

Historically, Cable TV (CATV) is a type of unidirectional medium for broadcasting, and one objective of its design is to provide analogy video broadcast channels to maximum number of subscribers under a minimum cost. Recently, it has been widely recognized that a high potential of capacity is provided for bidirectional data communication by the coaxial cable broadband technology, and various cable network systems have been developed and implemented. Among those well known technologies, DOCSIS is one standard which is developed and widely adopted in North America, in which a type of dedicated cable modem (CM) must be used at the client ends, and a cable modem termination system (CMTS) must be employed at the server ends (front ends). Meanwhile, along with the rapid development of the home network technology, many kinds of cable home networks are also developed, which utilize the coaxial cable of the CATV network, for example, MoCA (Multimedia over COAX Alliance), HCNA (Home Cable Network Access), and PLC (Power Line communication), etc.

On the other hand, thanks to the maturation of WiFi technology, the cost of WiFi compliant hardware and software is reduced a lot, which provides another possibility for access technology in the hybrid fiber coaxial cable network. In this field, one published Chinese patent No. CN1620132 discloses a system for integrating CATV with network communication, wherein IEEE802.11 signal is modulated and transmitted over the coaxial cable network of CATV at bandwidth of 0-65 MHz. This patent application is characterized in that the IEEE802.11 standard digital signal is first modulated from 2.4 GHz to 0-65 MHz by OFDM (Orthogonal Frequency Division Multiplex), QAM (Quadrature Amplitude Modulation), or QPSK (Quadrature Phase-Shift Keying), and then transmitted through the coaxial cable of CATV network. However, in this disclosed solution, there is only one channel in the cable. Therefore it still can not meet the real demands of high rate bandwidth data transmission.

Therefore, it is desirable to develop an improved cable access network, which overcomes drawbacks of the prior arts.

### SUMMARY OF THE INVENTION

In an aspect, a server used to transmit Ethernet data signals from an Ethernet network to multiple cable TV network clients or receive Ethernet data signals from the multiple cable TV network clients is provided. The server comprises multiple APs (access points), wherein the APs synchronously start a downlink transmission or an uplink transmission, and wherein during the downlink transmission the APs convert the Ethernet data signals into encoded and modulated RF signals and transmit the encoded and modulated RF signals to the multiple cable TV network clients, and during the uplink transmission the APs receive the encoded and modulated RF signals from the cable TV network clients and convert the encoded and modulated RF signals into the Ethernet data signals.

In another aspect, a server used to convert Ethernet data signals into encoded and modulated RF signals when transmitting Ethernet data signals from an Ethernet network to multiple cable TV network clients or convert the encoded and modulated RF signals into Ethernet data signals when receiving Ethernet data signals from the multiple cable TV network clients is described. The server comprises multiple APs (access points), wherein a load balance mechanism is used to the APs to choose an AP to connect a client according to the load information of each AP.

In a third aspect, a server used to transmit Ethernet data signals from an Ethernet network to multiple cable TV network clients or receive Ethernet data signals from the multiple cable TV network clients is described. The server comprises multiple APs (access points), wherein there is at least one backup AP in the server used to monitor the work status of the other APs when the other APs work properly or to replace a broken down AP when the AP breaks down.

In still another aspect, a client used to receive encoded and modulated RF signals from multiple APs in a cable TV network or transmit the encoded and modulated RF signals to an Ethernet network via the cable TV network is provided. The client comprises at least one modem which is used to receive synchronization information from the multiple APs to know the synchronous start of downlink transmission or an uplink transmission at the multiple APs, during the downlink transmission the modem being used to translate the encoded and modulated RF signals from the multiple APs into Ethernet data signals and during the uplink transmission the modem being used to translate the Ethernet data signals into the encoded and modulated RF signals.

In a further embodiment, a system comprising multiple APs and multiple clients is described. Wherein the APs synchronously start a downlink transmission or an uplink transmission, and wherein during the downlink transmission the APs convert the Ethernet data signals into encoded and modulated RF signals and transmit the encoded and modulated RF signals to the multiple cable TV network clients, and during the uplink transmission the APs receive the encoded and modulated RF signals from the cable TV network clients and convert the encoded and modulated RF signals into the Ethernet data signals; the multiple clients are used to receive synchronization information from the multiple APs to know the synchronous start of downlink transmission or an uplink transmission at the multiple APs, during the downlink transmission the multiple clients being used to translate the encoded and modulated RF signals from the multiple APs into Ethernet data signals and during the uplink transmission the multiple clients being used to translate the Ethernet data signals into the encoded and modulated RF signals.

In another aspect, a system used to transmit Ethernet data signals between an Ethernet network and a cable TV network is described. The system includes multiple APs and multiple clients, wherein the powers and the transmission rates of the transmission signals sent out from the multiple APs and the multiple clients are adaptable.

In an aspect, a method used by a server to transmit data signals from an Ethernet network to multiple cable TV network clients or receive data signals from the multiple cable TV network clients is described, with the server including multiple APs. The method comprises steps of synchronously start a downlink transmission or an uplink transmission among all APs, wherein during the downlink transmission, the APs convert the Ethernet data signals into encoded and modulated RF signals and send out the encoded and modulated RF signals to the multiple cable TV clients; and during the uplink transmission, the APs (20) receive the encoded and modulated RF signals from the multiple cable TV clients (40) and convert the encoded and modulated RF signals into Ethernet data signals.

These and other aspects, features and advantages will become apparent from the following description of non-limiting exemplary embodiments, which is to be read in connection with the accompany drawings.

### BRIEF DESCRIPTION OF DRAWINGS

FIG. 1 is a diagram illustrating the frame structure of a system for bidirectional data communication through CATV access network in accordance with the present invention.

### DETAILED DESCRIPTION OF PREFERRED EMBODIMENTS

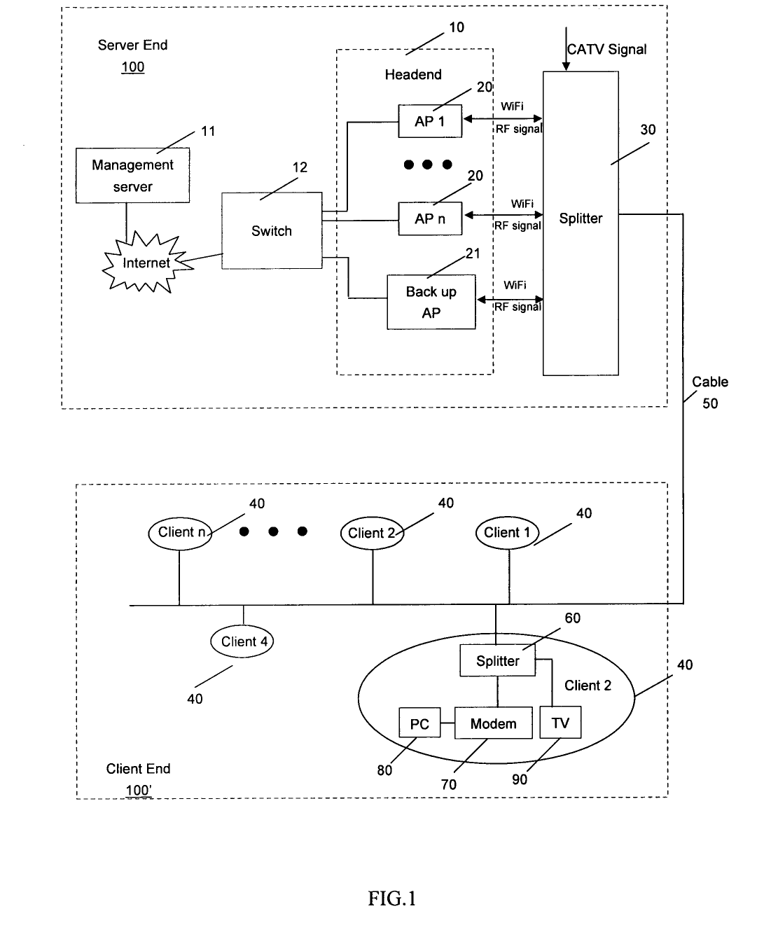

As illustrated in FIG. 1, it is an embodiment showing a system infrastructure for access to the internet through existing CATV cable network. Here the internet refers to Ethernet. At the server end of the system as shown by sign 100, during the downlink transmission (from the server end 100 to the client end 100′), a Headend apparatus 10 is provided between the internet and the CATV network. Said Headend apparatus 10 comprises multiple access points 20 (AP₁, . . . APₙ). The access points 20 are used to transform the Ethernet network signal received via a switch 12 into WiFi RF signal. The WiFi RF signals from the multiple access points 20 are combined together with CATV signal by a splitter 30. Here the splitter 30 represents a set of power splitters and band splitters. Then the splitter 30 is connected to a cable 50. The APs 20 in the embodiment provide data switching function over DataLink Layer of the OSI (Open System Interconnect) Reference Model. As shown in the FIG. 1, each client 40, for example client 2, at the remote client end 100′ of the CATV network, is provided with a splitter 60 for separating WiFi RF signal from analogy video signal of CATV, and transmitting relevant signals to modem 70 and the TV receiver 90 at client 2 respectively. Here, the splitter 60 can be replaced by power splitters and/or band pass filters. Finally, the data signal is translated by the modem 70 and sent to a PC 80 at client 2. In this embodiment, client 2 is used just for explanation. Other clients 40 at the client end 100′ may have basically the same devices as client 2. Of course, other devices known by those skilled in the art may be used too.

During the uplink transmission (from the client end 100′ to the server end 100), data signal from the PC 80 at client 2 is first translated by modem 70 into WiFi RF signal and then transmitted by the splitter 60 to cable 50. Finally the WiFi RF signal is translated by the associated AP 20 in the headend 10 into Ethernet signal and sent to the Ethernet network by the switch 12.

Accordingly, the following features will be implemented in the system for access to the internet through cable network of the embodiment to provide higher bandwidth capacity and better performance.

Time Division and Synchronization

In the above embodiment, there are several APs in the Headend 10 with each AP 20 being associated with one communication channel. When an AP 20 is receiving a weak signal from a modem 70 while another AP 20 is sending out a much stronger signal to the client 100′, the signal to be received by the AP 20 will be submerged by the signal to be sent out by the other AP 20. To solve this problem, all APs 20 in the Headend 10 should work synchronously both during the uplink transmission (from the client end 100′ to the server end 100) and during the downlink transmission (from the server end 100 to the client end 100′), so that they can send out signals synchronously and receive signals synchronously. Because if the synchronization mechanism is used, when an AP 20 is sending out a strong signal through a channel, the others are also sending out signals via other channels. While when an AP 20 is receiving a weak signal the others may receive signals that are not very strong or no signal to receive. So the weak signal won't be submerged by the stronger one. To guarantee the synchronization of all APs 20, a lot of methods can be used. For example, the APs 20 in the Headend 10 can be connected in a bus topological structure. One AP 20 serves as the master AP, and the others serve as slave AP. The master AP will send out a synchronization signal and/or a synchronization message to all slave APs to make all APs 20 work synchronously. At the same time, each AP 20 should send out a synchronization information to the modems 70 at the client end 100′ to synchronize the modems 70.

To implement the synchronization mechanism, TDMA (Time Division Multiple Access) method is necessary. In the present embodiment, the whole timeslots of each AP are separated into downlink transmission and uplink transmission. The APs 20 in the Headend 10 and the modems 70 communicate with each other during the respective uplink transmission or downlink transmission accordingly.

Asymmetry

In the system as shown in FIG. 1, the uplink and downlink transmission of the above embodiment system will employ different modulation methods (e.g. QAM, QPSK, BPSK, etc.) to support different data rates on Physical Layer of OSI (Open System Interconnect) Reference Model. The downlink and the uplink may have different transmitting power.

The reason using asymmetry policy is that in the present cable TV access network, the distance between the Headend 10 and the modems 70 at the client end is long, so the signal attenuation is large. And also in this kind of system, the downlink transmission from the Headend 10 to multiple clients 40 at the client end 100′ and the uplink transmission from the multiple clients 40 at the client end 100′ to the Headend 10 are different.

For example, at the client end 100′, within 5 MHz-2.5 GHz frequency domain, the signal power is weak, while the noise is decreased with the increase of the frequency. At the same time there is no signal transmitting sources with frequency band between 110 MHz and 862 MHz (CATV broadcast frequency band), and the power of signals at the receivers is mainly under 60 dBuV, and this facilitates the receipt of high frequency signals (for example, 800-1200 MHz), because the high frequency signals won't be affected much by the low power signals such as 60 dBuV signals. Meanwhile, at the Headend 10 (APs 20), the signal power within the frequency domain of 5 MHz-2.5 GHz is strong. Because the frequency band between 110 MHz and 800 MHz is full of transmitters (for example, digital TV, analog TV, etc.), the frequency band between 800 MHz and 1200 MHz is affected heavily even if the filters is used. So the transmitting power at the client end should be stronger than the transmitting power at the APs 20 of the Headend 10, so as to decrease the effect of high noise caused by strong signal power to an AP 20. While at the client end, the receiving devices at the frequency band of 50 MHz to 800 MHz usually don't perform filtering, so a over-high frequency signal (for example, 800-1200 MHz) may block the receipt of signal at the receiving devices. So the signal should not be very strong. If at the same time the attenuation is very high, the transmitting power at the APs of Headend should be strengthened to keep the transmitting power at the modem 70 of the client to be at a higher level. And thus the transmitting power of APs 20 at Headend 10 will be larger than the transmitting power of the modem 70 at client end. For example, when the attenuation of the cable is 70 dB, the downlink signal power is set up to 115 dBuV, and QAM64 (Quadrature Amplitude Modulation) is used, to get the optimal performance; at the same time, the uplink signal sent by modem is set up to 105 dBuv, and QAM16 or PSK (Phase Shift Keying) is used. In this case, Downlink power is larger than uplink power. Another example, when the attenuation of the cable is 50 dB, the downlink signal output by an AP 30 is set up to 100 dBuV, and QAM64 should be used, to get the optimal performance with lower power consumption; at the same time, the uplink signal output by modem 70 is also set up to 105 dBuV, QAM64 should be used. In this case, downlink power is weaker than uplink power.

Backup

In the Headend apparatus 30, there is at least one backup AP 21 to monitor all the other APs 20. When in the normal communication mode, the backup APs 21 only monitor the other APs 20. And when there is an AP 20 breaks down, one of the backup APs 21 will turn from the monitoring status into working status to replace the broken down AP 20. For example, the back up APs 21 can monitor all the other APs 20 through the synchronization frames sent by other APs 20 which operate in the normal communication mode. When all the monitored APs 20 under the monitoring domain send synchronization frames at the normal interval, the backup APs 21 will just stay in the backup status and don't send any synchronization frames. Once it is found that some AP 20 doesn't send out any synchronization frames for a period longer than a pre-defined timeout threshold, which is an indication that there is some problem with the specific AP 20, one of the backup APs 20 will turn from the monitoring status into the communication status, and send the synchronization information on the cable access network to announce it is capable of communicating with the Modem 60. In this way, the system will continue to provide normal communication functionality to the Modems in the network when some of the APs 20 have problems, and as a result, a more stable network is ensured.

Load Management and Balance

This mechanism means that the traffic load of the network can be shared by many APs in the same cable access network.

Basically, there are some non-overlapping channels in Wi-Fi system and we denote the number of non-overlapping channels as n. In the cable access network with the same coverage, n APs can be deployed and each of them can operate in one of the non-overlapping channels. In the synchronization frame sent by an AP, the remained uplink bandwidth for further allocation will be encapsulated. Accordingly, the Modems 70 under this coverage will check all available channels to inspect the synchronization information sent by each AP 20, select an AP 20 with the largest available uplink bandwidth for allocation, tune into the chosen AP's channel and send registration frame to associate with the chosen AP. When this load assignment and balance method is deployed, the available network bandwidth can be greatly increased for a group of Modems.

Secondly, this function can be implemented by the APs 20 in the headend 10. The entire traffic load can be coordinated by the APs 20 in the headend 10, and the overloaded or unsuitable AP will reject it when a modem 70 tries to associate with the AP 20 (e.g. a modem 70 tries to connect APs when it is powered on), then the modem 70 selects another channel to try again circularly.

For example, because there are three or more non-overlapping channels within the current 802.11 compliant WiFi solutions (For example, at least channel 1, 6 and 11), modems 70 at the client end will know the load condition of these three channels and choose a channel according to above load management and balance mechanism respectively to make sure the channels they use don't overlapping and have no interference.

In the above embodiment, there can be a management server in the system to maintain and mange the whole access network system. It can provide user management, network line maintenance, network facility maintenance, failure management, performance management, topology management, configuration management, security management and failure/alarm management.

Although the embodiments which incorporates the teachings of the present invention has been shown and described in detail here, those skilled in the art can readily revise many other varied embodiments that still incorporate these teachings. For example, the principle of the invention can also be used in MoCA (Multimedia over COAX Alliance) systems. It is noted that modifications and variations can be made by persons skilled in the art in light of the above teachings. It is to be understood that those units or devices described in the embodiments can be integrated in different ways have the similar effects.

1-40. (canceled)

41. Method in a head end device for transmitting Ethernet data signals from an Ethernet network to multiple cable TV network clients or for receiving Ethernet data signals from the multiple cable TV network clients, the head end device comprising multiple access points for transmitting and receiving on respective channels, said method comprising the steps of:
synchronizing the downlink transmissions of said multiple access points;
converting Ethernet data signals into encoded and modulated RF signals and transmitting the encoded and modulated RF signals to the multiple cable TV network clients;
receiving the encoded and modulated RF signals from the cable TV network clients;
and converting the encoded and modulated RF signals into Ethernet data signals.

42. Method according to claim 41, wherein the step of synchronizing the multiple access points is carried out by one of the multiple access points sending out synchronization messages and/or synchronization signals to the other access point.

43. Method according to claim 42, wherein the multiple access point broadcast synchronization information to the multiple cable TV network clients to inform the multiple cable TV network clients of the start of downlink transmission or the uplink transmission time periods.

44. Method according to claim 43 wherein the uplink and downlink transmissions use time division multiple access.

45. Method according to claim 44, wherein a downlink transmission period or an uplink transmission period includes multiple time slots.

46. Method according to claim 41, wherein each access point broadcasts load information to the multiple cable TV network clients for them to choose an access point to set up a connection with.

47. Method according to claim 46, wherein overloaded or unsuitable access points reject setting up a connection from a client according to their load.

48. Method according to claim 41, comprising the step of monitoring the status of other access points by at least one back up access point of the head end device when the other access points work properly and to replace a broken access point.

49. Method according to claim 41, comprising the step of using a splitter which includes at least one power splitter or/and band splitter to combine encoded and modulated RF signals from access points with cable TV signals and send the combined signals to the cable TV network.

50. Method for receiving encoded and modulated RF signals from multiple access points in a cable TV network or for transmitting encoded and modulated RF signals to an Ethernet network via the cable TV network, the method being carried out by a client device, the method comprising steps of:
receiving synchronization information from the multiple access points indicating synchronous start of downlink transmission or uplink transmission;
during the downlink transmission the modem, translating the encoded and modulated RF signals from the multiple access points into Ethernet data signals;
and during the uplink transmission the modem translating the Ethernet data signals into the encoded and modulated RF signals.

51. Method according to claim 50, wherein uplink and downlink transmissions use time division multiple access.

52. Method according to claim 51, comprising the step of receiving broadcasted load information from each access point for the client device to choose an access point to set up a connection with.

53. Method according to claim 52, wherein when the client is rejected by an access point and when setting up a connection, the client device will try to connect to other access points by turns.
